(19) United States
(12) Patent Application Publication
(10) Pub. No.: US 2006/0094286 A1
(43) Pub. Date: May 4, 2006

(54) Apparatus including an electronic device capable of communicating using first and second signaling protocols

(75) Inventors: Chin-Chou Lee, Hsinchu Hsien (TW); Chin-Hsin Yang, Hsinchu Hsien (TW); Chien-Hsing Hsieh, Hsinchu Hsieh (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Pixart Imaging Inc., Hsinchu Hsien (TW)

(21) Appl. No.: 11/040,701

(22) Filed: Jan. 21, 2005

(30) Foreign Application Priority Data
Nov. 3, 2004 (TW) 93133458

(51) Int. Cl. H01R 3/00

(52) U.S. Cl. 439/489

(57) ABSTRACT

An apparatus includes an electronic device and an adapter. The electronic device includes an electrical connector, and a processor having a detecting pin coupling to the electrical connector. The processor is operable so as to communicate through the electrical connector using a first signaling protocol when the detecting pin has a first state, and using a second signaling protocol when the detecting pin has a second state. The adapter includes first and second adapter connectors serves to change the detecting pin of the processor of the electronic device from the first state to the second state.

### BACKGROUND OF THE INVENTION

1. Field of the Invention

The invention relates to an apparatus, more particularly to an apparatus which includes an electronic device that is capable of communicating using first and second signaling protocols.

2. Description of the Related Art

U.S. Pat. No. 6,691,201 discloses a conventional peripheral device that includes an integrated circuit capable of communicating using universal serial bus (USB) and personal system 2 (PS/2) signaling protocols. The integrated circuit of the conventional peripheral device is configured to select one of the USB and PS/2 signaling protocols in response to a detected signaling protocol of a connected bus.

The conventional peripheral device is disadvantageous in that the detection of the signaling protocol of the connected bus is both complicated and prone to error.

### SUMMARY OF THE INVENTION

Therefore, the object of the present invention is to provide an apparatus which includes an electronic device that is capable of communicating using first and second signaling protocols, and which is capable of overcoming the aforesaid drawbacks of the prior art.

According to one aspect of the present invention, an apparatus comprises an electronic device and an adapter. The electronic device includes an electrical connector, and a processor that includes a detecting pin coupled to the electrical connector. The processor is operable so as to communicate through the electrical connector using a first signaling protocol when the detecting pin has a first state, and using a second signaling protocol when the detecting pin has a second state. The adapter includes first and second adapter connectors, and a state-setting unit. The first adapter connector of the adapter has a connector specification different from that of the electrical connector of the electronic device. The second adapter connector of the adapter is coupled to the first adapter connector of the adapter, and mates removably with the electrical connector of the electronic device. The state-setting unit is coupled to the first and second adapter connectors of the adapter, and serves to change the detecting pin of the processor of the electronic device from the first state to the second state.

According to another aspect of the present invention, an adapter, which is for an electronic device, comprises first and second adapter connectors, and a state-setting unit. The electronic device includes an electrical connector, and a processor that includes a detecting pin coupled to the electrical connector. The processor is operable so as to communicate through the electrical connector using a first signaling protocol when the detecting pin has a first state, and using a second signaling protocol when the detecting pin has a second state. The first adapter connector has a connector specification different from that of the electrical connector of the electronic device. The second adapter connector is coupled to the first adapter connector, and is adapted to mate removably with the electrical connector of the electronic device. The state-setting unit is coupled to the first and second adapter connectors, and serves to change the detecting pin of the processor of the electronic device from the first state to the second state.

According to yet another aspect of the present invention, an apparatus comprises an electronic device that includes an electrical connector and a processor. The processor includes a detecting pin coupled to the electrical connector. The processor is operable so as to communicate through the electrical connector using a first signaling protocol when the detecting pin has a first state, and using a second signaling protocol when the detecting pin has a second state.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram of the first preferred embodiment of an apparatus according to the present invention;

FIG. 2 is a schematic diagram to illustrate an electronic device of the preferred embodiment when connected to a personal computer;

FIG. 3 is a schematic diagram of the second preferred embodiment of an apparatus according to the present invention; and

FIG. 4 is a schematic diagram to illustrate an electronic device of the preferred embodiment when connected to a personal computer.

### DETAILED DESCRIPTION OF THE PREFERRED EMBODIMENTS

Before the present invention is described in greater detail, it should be noted that like elements are denoted by the same reference numerals throughout the disclosure.

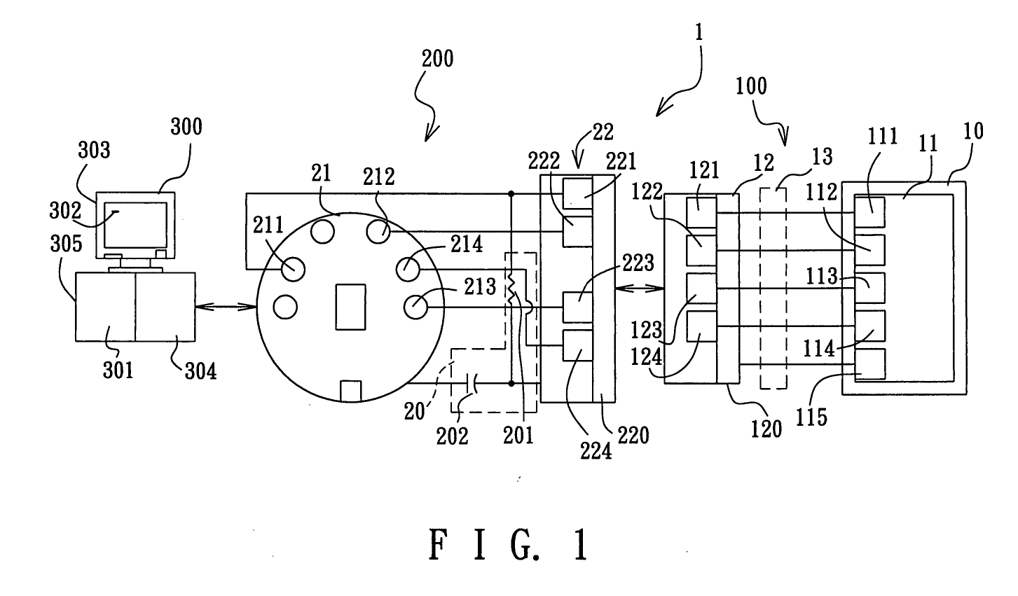

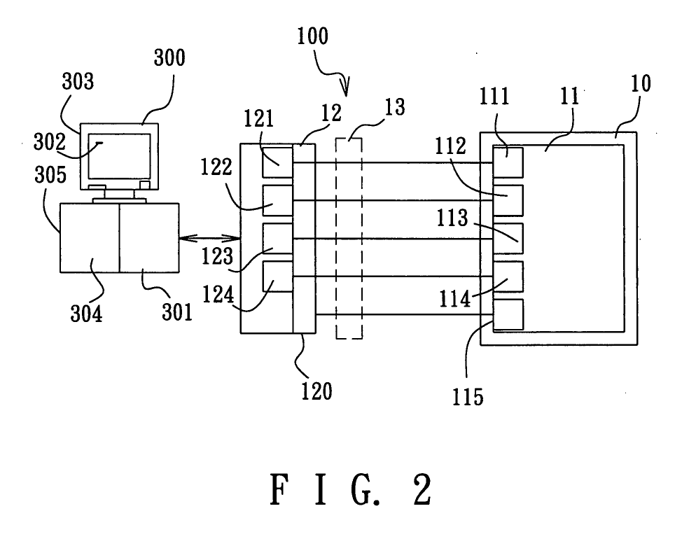

Referring to FIGS. 1 and 2, the first preferred embodiment of an apparatus 1 according to this invention is shown to include an electronic device 100 and an adapter 200.

The electronic device 100 in this embodiment is a computer mouse that is used to control movement of a cursor 302 on a computer screen 303 of a personal computer 300, in a known manner. In an alternative embodiment, the electronic device 100 may be any peripheral device that complies with a human interface device (HID) specification.

The personal computer 300 further includes a system unit 305 that is coupled to the computer screen 303 and that has universal serial bus (USB) and personal system 2 (PS/2) connectors 301, 304.

The computer mouse 100 includes a housing 10, an electrical connector 12, and a processor 11.

The electrical connector 12 of the computer mouse 100 is mounted on and is accessible from the exterior of the housing 10. In this embodiment, the electrical connector 12 of the computer mouse 100 is a USB connector, and includes a power supply terminal 121, a pair of input/output terminals 122, 123, a ground terminal 124, and a metal protective shield 120. It is noted that the input/output terminals 122, 123 of the USB connector 12 of the computer mouse 100 serve as the D− and D+ terminal of a USB connector, respectively. The metal protective shield 120 of the USB connector 12 surrounds and is free from electrical contact with the power supply terminal 121, the D− and D+ terminals 122, 123, and the ground terminal 124 of the USB connector 12.

The processor 11 of the computer mouse 100 is disposed in the housing 10, and includes a power supply pin 111, a pair of input/output pins 112, 113, a ground pin 114, and a general purpose input/output (GPIO) pin 115. It is noted that the GPIO pin 115 of the processor 11 of the computer mouse 100 is pulled low internally, and serves as a detecting pin. The power supply pin 111, the input/output pins 112, 113, and the ground pin 114 of the processor 11 of the computer mouse 100 are connected electrically and respectively to the power supply terminal 121, the D− and D+ terminals 122, 123, and the ground terminal 124 of the USB connector 12 of the computer mouse 100 through a cable 13. The processor 11 of the computer mouse 100 is operable so as to communicate through the USB connector 12 of the computer mouse 100 using a USB signaling protocol when the detecting pin 115 has a low logic state, and using a PS/2 signaling protocol when the detecting pin 115 has a high logic state.

When the USB connector 12 of the computer mouse 100 is connected directly to the USB connector 301 of the system unit 305 of the personal computer 300, as best shown in FIG. 2, since the detecting pin 115 of the processor 11 of the computer mouse 100 is pulled low, the processor 11 of the computer mouse 100 communicates with the system unit 305 of the personal computer 300 through the USB connector 12 of the computer mouse 100 using the USB signaling protocol.

The adapter 200 includes first and second adapter connectors 21, 22, and a state-setting unit 20. The first adapter connector 21 of the adapter 200 has a connector specification different from that of the USB connector 12 of the computer mouse 100. In this embodiment, the first adapter connector 21 of the adapter 200 is a PS/2 connector, and includes a power supply terminal 211, a pair of input/output terminals 212, 213, and a ground terminal 214. It is noted that the input/output terminals 212, 213 of the PS/2 connector 21 of the adapter 200 serve as the data and clock terminals of a PS/2 connector, respectively. The second adapter connector 22 of the adapter 200 is coupled to the PS/2 connector 21 of the adapter 200, and mates removably with the USB connector 12 of the computer mouse 100. In this embodiment, the second adapter connector 22 of the adapter 200 is a USB connector, and includes a power supply terminal 221, a pair of input/output terminals 222, 223, and a ground terminal 224, and a metal protective shield 220. It is noted that the input/output terminals 222, 223 of the USB connector 22 of the adapter 200 serve as the D− and D+ terminals of a USB connector. The power supply terminal 221, the D− and D+ terminals 222, 223, and the ground terminal 224 of the USB connector 22 of the adapter 200 are connected electrically and respectively to the power supply terminal 211, the data and clock terminals 212, 213, and the ground terminal 214 of the PS/2 connector 21 of the adapter 200. The metal protective sleeve 220 of the USB connector 22 of the adapter 200 surrounds and is free from electrical contact with the power supply terminal 221, the D− and D+ terminals 222, 223, and the ground terminal 224 of the USB connector 22 of the adapter 200.

The state-setting unit 20 of the adapter 200 is coupled to the PS/2 and USB connectors 21, 22 of the adapter 200, and serves to change the detecting pin 115 of the processor 11 of the computer mouse 100 from the low logic state to the high logic state, in a manner that will be described hereinafter.

The state-setting unit 20 includes a pull-up circuit that is coupled to the power supply terminal 221 and the metal protective sleeve 220 of the USB connector 22 of the adapter 200. In this embodiment, the pull-up circuit includes passive components. Preferably, the passive components are resistor and capacitor 201, 202. In an alternative embodiment, the passive components are resistor and inductor. Although the pull-up circuit of the state-setting unit 20 of the adapter 200 is exemplified using passive components, it should be apparent to those skilled in the art that a jumper (not shown) may be used as well.

When the USB connector 22 of the adapter 200 is connected to the USB connector 12 of the computer mouse 100, as best shown in FIG. 1, the power supply terminal 221, the D− and D+ terminals 222, 223, the ground terminal 224, and the metal protective sleeve 220 of the USB connector 22 of the adapter 200 are in respective electrical contact with the power supply terminal 121, the D− and D+ terminals 122, 123, the ground terminal 124, and the metal protective sleeve 120 of the USB connector 12 of the computer mouse 100. As such, when the PS/2 connector 21 of the adapter 200 is connected electrically to the PS/2 connector 304 of the system unit 305 of the personal computer 300, as best shown in FIG. 1, the power supply terminal 211 of the PS/2 connector 21 of the adapter 200 receives a power signal from the system unit 305 of the personal computer 300. As a result, the pull-up circuit of the state-setting unit 20 pulls up the detecting pin 115 of the processor 11 of the computer mouse 100 from the low logic state to the high logic state, thereby enabling the processor 11 of the computer mouse 100 to communicate with the system unit 305 of the personal computer 300 through the USB connector 12 of the computer mouse 100 using the PS/2 signaling protocol.

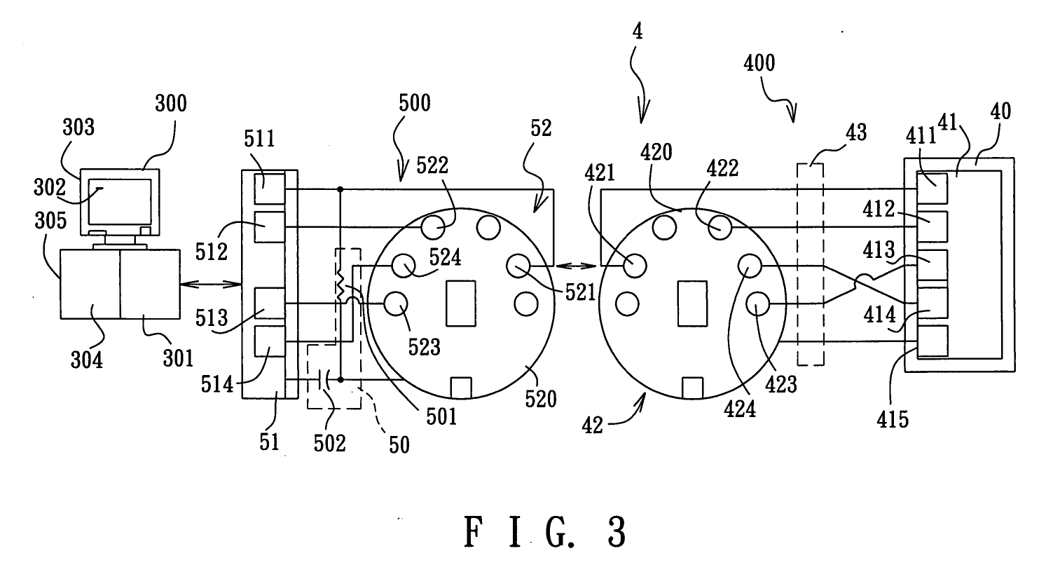

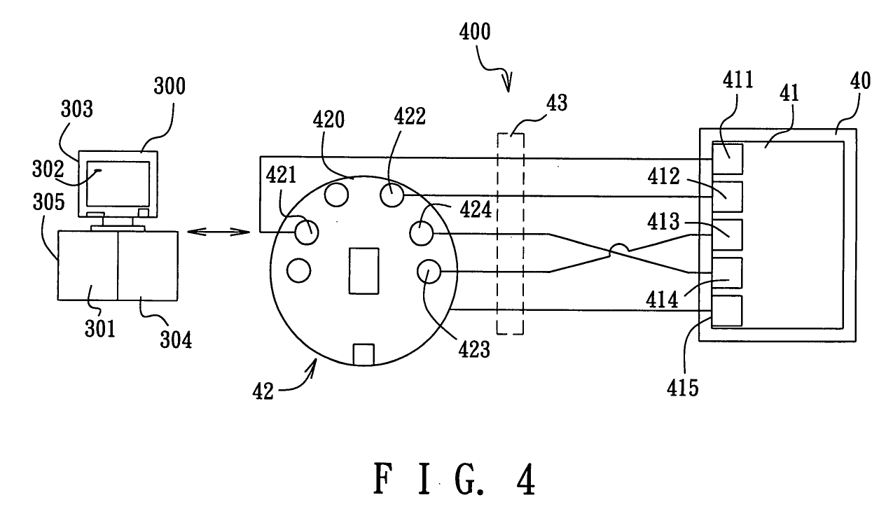

Referring to FIGS. 3 and 4, the second preferred embodiment of an apparatus 4 according to this invention is shown to include an electronic device 400 and an adapter 500.

The electronic device 400 in this embodiment, as in the previous embodiment, is a computer mouse.

The computer mouse 400 includes a housing 40, an electrical connector 42, and a processor 41.

The electrical connector 42 of the computer mouse 400 is mounted on and is accessible from the exterior of the housing 40 of the computer mouse 400. In this embodiment, the electrical connector 42 of the computer mouse 400 is a PS/2 connector, and includes a power supply terminal 421, a pair of input/output terminals 422, 423, a ground terminal 424, and a metal protective shield 420. It is noted that the input/output terminals 422, 423 of the PS/2 connector 42 of the computer mouse 400 serve as the data and clock terminals of a PS/2 connector, respectively. The metal protective shield 420 of the PS/2 connector 42 of the computer mouse 400 surrounds and is free from electrical contact with the power supply terminal 421, the data and clock terminals 422, 423, and the ground terminal 424 of the PS/2 connector 42 of the computer mouse 400.

The processor 41 of the computer mouse 400 is disposed in the housing 40, and includes a power supply pin 411, a pair of input/output pins 412, 413, a ground pin 414, and a general purpose input/output (GPIO) pin 415. It is noted that the GPIO pin 415 of the processor 41 of the computer mouse 400 is pulled low internally, and serves as a detecting pin. The power supply pin 411, the input/output pins 412, 413, and the ground pin 414 of the processor 41 of the computer mouse 400 are connected electrically and respectively to the power supply terminal 421, the data and clock terminals 422, 423, and the ground terminal 424 of the PS/2 connector 42 of the computer mouse 400 through a cable 43. The processor 41 of the computer mouse 400 is operable so as to communicate through the PS/2 connector 42 of the computer mouse 400 using the PS/2 signaling protocol when the detecting pin 415 has a low logic state, and using the USB signaling protocol when the detecting pin 415 has a high logic state.

When the PS/2 connector 42 of the computer mouse 400 is connected directly to the PS/2 connector 304 of the system unit 305 of the personal computer 300, as best shown in FIG. 4, since the detecting pin 415 of the processor 41 of the computer mouse 400 is pulled low, the processor 41 of the computer mouse 400 communicates with the system unit 305 of the personal computer 300 through the PS/2 connector 42 of the computer mouse 400 using the PS/2 signaling protocol.

The adapter 500 includes first and second adapter connectors 51, 52 and a state-setting unit 50. The first adapter connector 51 of the adapter 500 has a connector specification different from that of the PS/2 connector 42 of the computer mouse 400. In this embodiment, the first adapter connector 51 of the adapter 500 is a USB connector, and includes a power supply terminal 511, a pair of input/output terminals 512, 513, and a ground terminal 514. It is noted that the input/output terminals 512, 513 of the USB connector 51 of the adapter 500 serve as the D− and D+ terminals of a USB connector, respectively. The second adapter connector 52 of the adapter 500 is coupled to the USB connector 51 of the adapter 500, and mates removably with the PS/2 connector 42 of the computer mouse 400. In this embodiment, the second adapter connector 52 of the adapter 500 is a PS/2 connector, and includes a power supply terminal 521, a pair of input/output terminals 522, 523, and a ground terminal 524, and a metal protective shield 520. It is noted that the input/output terminals 522, 523 of the PS/2 connector 52 of the adapter 500 serve as the data and clock terminals of a PS/2 connector. The power supply terminal 521, the data and clock terminals 522, 523, and the ground terminal 524 of the PS/2 connector 52 of the adapter 500 are connected electrically and respectively to the power supply terminal 511, the D− and D+ terminals 512, 513, and the ground terminal 514 of the USB connector 51 of the adapter 500. The metal protective sleeve 520 of the PS/2 connector 52 of the adapter 500 surrounds and is free from electrical contact with the power supply terminal 521, the data and clock terminals 522, 523, and the ground terminal 524 of the PS/2 connector 52 of the adapter 500.

The state-setting unit 50 of the adapter 500 is coupled to the USB and PS/2 connectors 51, 52 of the adapter 500, and serves to change the detecting pin 415 of the processor 41 of the computer mouse 400 from the low logic state to the high logic state, in a manner that will be described hereinafter.

The state-setting unit 50 includes a pull-up circuit that is coupled to the power supply terminal 521 and the metal protective sleeve 520 of the PS/2 connector 52 of the adapter 500. In this embodiment, the pull-up circuit includes passive components. Preferably, the passive components are resistor and capacitor 501, 502. In an alternative embodiment, the passive components are resistor and inductor. Although the pull-up circuit of the state-setting unit 50 of the adapter 500 is exemplified using passive components, it should be apparent to those skilled in the art that a jumper (not shown) may be used as well.

When the PS/2 connector 52 of the adapter 500 is connected to the PS/2 connector 42 of the computer mouse 400, as best shown in FIG. 3, the power supply terminal 521, the data and clock terminals 522, 523, the ground terminal 524, and the metal protective sleeve 520 of the PS/2 connector 52 of the adapter 500 are in respective electrical contact with the power supply terminal 421, the data and clock terminals 422, 423, the ground terminal 424, and the metal protective sleeve 420 of the PS/2 connector 42 of the computer mouse 400. As such, when the USB connector 51 of the adapter 500 is connected electrically to the USB connector 301 of the system unit 305 of the personal computer 300, as best shown in FIG. 3, the power supply terminal 511 of the USB connector 51 of the adapter 500 receives a power signal from the system unit 305 of the personal computer 300. As a result, the pull-up circuit of the state-setting unit 50 pulls up the detecting pin 415 of the processor 41 of the computer mouse 400 from the low logic state to the high logic state, thereby enabling the processor 41 of the computer mouse 400 to communicate with the system unit 305 of the personal computer 300 through the PS/2 connector 42 of the computer mouse 400 using the USB signaling protocol.

It has thus been shown that the apparatus 1, 4 of this invention includes an electronic device 100, 400 and an adapter 200, 500. The electronic device 100, 400 communicates with another electronic device, e.g., the personal computer 300, using a first signaling protocol when the electronic device 100, 400 is connected directly to the other electronic device 300, and using a second signaling protocol when the electronic device 100, 400 is connected to the other electronic device 300 through the adapter 200, 500.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An apparatus, comprising:
an electronic device including
an electrical connector, and
a processor that includes a detecting pin coupled to said electrical connector, said processor being operable for communicating through said electrical connector using a first signaling protocol when said detecting pin has a first state, and using a second signaling protocol when said detecting pin has a second state; and
an adapter including
a first adapter connector that has a connector specification different from that of said electrical connector of said electronic device,
a second adapter connector that is coupled to said first adapter connector of said adapter and that mates removably with said electrical connector of said electronic device, and
a state-setting unit that is coupled to said first and second adapter connectors of said adapter, and that serves to change said detecting pin of said processor of said electronic device from the first state to the second state.

2. The apparatus as claimed in claim 1, wherein the first state is a low logic state, and the second state is a high logic state.

3. The apparatus as claimed in claim 2, wherein said electrical connector of said electronic device includes a power supply terminal, and a metal protective shield that is free from electrical contact with said power supply terminal of said electrical connector of said electronic device,
said detecting pin of said processor of said electronic device being pulled low internally and being coupled to said metal protective shield of said electrical connector of said electronic device.

4. The apparatus as claimed in claim 3, wherein said second adapter connector of said adapter includes a power supply terminal, and a metal protective sleeve that is free from electrical contact with said power supply terminal of said second adapter connector of said adapter, said power supply terminal and said metal protective sleeve of said second adapter connector of said adapter being in respective electrical contact with said power supply terminal and said metal protective sleeve of said electrical connector of said electronic device when said second adapter connector of said adapter is connected to said electrical connector of said electronic device.

5. The apparatus as claimed in claim 4, wherein said state-setting unit includes a pull-up circuit that is coupled to said power supply terminal and said metal protective sleeve of said second adapter connector of said adapter, and that pulls up said detecting pin of said processor of said electronic device from the first state to the second state when said second adapter connector of said adapter is connected to said electrical connector of said electronic device and when said power supply terminal of said second adapter connector of said adapter receives a power signal.

6. The apparatus as claimed in claim 5, wherein said pull-up circuit includes at least one passive component.

7. The apparatus as claimed in claim 6, wherein each said passive component is one of a resistor and a capacitor.

8. The apparatus as claimed in claim 1, wherein the first signaling protocol conforms to one of a universal serial bus (USB) protocol and a PS/2 protocol.

9. The apparatus as claimed in claim 8, wherein the second signaling protocol conforms to the other one of the USB protocol and the PS/2 protocol.

10. The apparatus as claimed in claim 1, wherein said electrical connector of said electronic device is one of a USB connector and a PS/2 connector.

11. The apparatus as claimed in claim 10, wherein said first adapter connector of said adapter is the other one of the USB connector and the PS/2 connector.

12. The apparatus as claimed in claim 1, wherein the detecting pin of said processor of said electronic device is a general purpose input/output (GPIO) pin.

13. An adapter for an electronic device, the electronic device including an electrical connector, and a processor that includes a detecting pin coupled to the electrical connector, the processor being operable for communicating through the electrical connector using a first signaling protocol when the detecting pin has a first state, and using a second signaling protocol when the detecting pin has a second state, said adapter comprising:
a first adapter connector having a connector specification different from that of the electrical connector of the electronic device;
a second adapter connector coupled to said first adapter connector and adapted to mate removably with the electrical connector of the electronic device; and
a state-setting unit, coupled to said first and second adapter connectors, for changing the detecting pin of the processor of the electronic device from the first state to the second state.

14. The adapter as claimed in claim 13, wherein the first state is a low logic state, and the second state is a high logic state.

15. The adapter as claimed in claim 14, the electrical connector of the electronic device including a power supply terminal, and a metal protective shield that is free from electrical contact with the power supply terminal of the electrical connector of the electronic device,
the detecting pin of the processor of the electronic device being pulled low internally and being coupled to the metal protective shield of the electrical connector of the electronic device,
wherein said second adapter connector includes a power supply terminal, and a metal protective sleeve that is free from electrical contact with said power supply terminal of said second adapter connector, said power supply terminal and said metal protective sleeve of said second adapter connector being adapted to establish respective electrical contact with the power supply terminal and the metal protective sleeve of the electrical connector of the electronic device when said second adapter connector is connected to the electrical connector of the electronic device.

16. The adapter as claimed in claim 15, wherein said state-setting unit includes a pull-up circuit coupled to said power supply terminal and said metal protective sleeve of said second adapter connector, said pull-up circuit pulling up the detecting pin of the processor of the electronic device from the first state to the second state when said second adapter connector is connected to the electrical connector of the electronic device and when said power supply terminal of said second adapter connector receives a power signal.

17. The adapter as claimed in claim 16, wherein said pull-up circuit includes at least one passive component.

18. The adapter as claimed in claim 17, wherein each said passive component is one of a resistor and a capacitor.

19. The adapter as claimed in claim 13, wherein said first adapter connector is one of a USB connector and a PS/2 connector.

20. The adapter as claimed in claim 19, wherein said second adapter connector is the other one of the USB connector and the PS/2 connector.

21. An apparatus, comprising:
an electronic device including
an electrical connector, and
a processor that includes a detecting pin coupled to said electrical connector, said processor being operable for communicating through said electrical connector using a first signaling protocol when said detecting pin has a first state, and using a second signaling protocol when said detecting pin has a second state.

22. The apparatus as claimed in claim 21, wherein said detecting pin of said processor of said electronic device is a general purpose input/output (GPIO) pin.

23. The apparatus as claimed in claim 21, wherein the first state is a low logic state and the second state is a high logic state.

24. The apparatus as claimed in claim 21, wherein the first signaling protocol conforms to one of a USB protocol and a PS/2 protocol.

25. The apparatus as claimed in claim 24, wherein the second signaling protocol conforms to the other one of the USB protocol and the PS/2 protocol.
